(19) United States
(12) Patent Application Publication
(10) Pub. No.: US 2025/0378347 A1
(43) Pub. Date: Dec. 11, 2025

(54) SYSTEMS AND METHODS FOR TRAINING AND EVALUATING MULTIMODAL NEURAL NETWORK BASED LANGUAGE MODELS

(71) Applicant: Salesforce, Inc., San Francisco, CA (US)

(72) Inventors: Artemis Panagopoulou, Palo Alto, CA (US); Le Xue, Mountain View, CA (US); Honglu Zhou, Palo Alto, CA (US); Silvio Savarese, Palo Alto, CA (US); Ran Xu, Mountain View, CA (US); Juan Carlos Niebles Duque, Mountain View, CA (US); Caiming Xiong, Menlo Park, CA (US)

(21) Appl. No.: 18/973,803

(22) Filed: Dec. 9, 2024

Related U.S. Application Data
(60) Provisional application No. 63/656,510, filed on Jun. 5, 2024.

(51) Int. Cl. G06N 3/096; B60W 50/00; B60W 60/00; G06N 3/045

(52) U.S. Cl. CPC G06N 3/096; B60W 50/00; B60W 60/001; G06N 3/045; B60W 2050/0075; B60W 2556/45

(57) ABSTRACT

Embodiments described herein provide a method of building an artificial intelligence (AI) agent to respond to a task request from a user. The method includes: receiving a set of single-modal data samples of a plurality of modalities; selecting a first single-modal data sample of a first modality and a second single-modal data sample of a second modality; generating a question associated with the first single-modal data sample and the second single-modal data sample; generating an answer with a reasoning to the question based on a second input prompt; training, a second neural network based language model, using a dataset comprising the question and the answer to generate a candidate answer in response to a training query; building the AI conversation bot through an application programming interface to the trained second neural network language model; and generating, using the AI conversation bot, a response to the task request.

### CROSS REFERENCE(S)

The instant application is a nonprovisional of and claim priority under 35 U.S.C. 119 to U.S. provisional application No. 63/656,510, filed Jun. 5, 2024, which is hereby expressly incorporated by reference herein in its entirety.

### TECHNICAL FIELD

The embodiments relate generally to machine learning systems for cross-modal reasoning, and more specifically to systems and methods for training and evaluating multimodal neural network based language models.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task. However, training or evaluating such multimodal LLMs remains challenging.

### BRIEF DESCRIPTION OF THE DRAWINGS

FIG. 1A shows an application of a user device with multimodal functions, according to some embodiments.

FIG. 1B is a simplified diagram illustrating a multimodal training and evaluation framework, according to some embodiments.

FIGS. 1C and 1D show a process for generating multimodal training/evaluation data, according to some embodiments.

FIG. 1E shows certain examples used in the generation of multimodal training/evaluation data, according to some embodiments.

FIG. 1F shows topic distribution and corresponding examples in the multimodal training/evaluation data, according to some embodiments.

FIG. 2A is a simplified diagram illustrating a computing device implementing the multimodal training and evaluation framework described in FIGS. 1A-1F, according to some embodiments.

FIG. 2B is a simplified diagram illustrating a neural network structure, according to some embodiments.

FIG. 3 is a simplified block diagram of a networked system suitable for implementing the multimodal training and evaluation framework described in FIGS. 1A-1F, 2A, and 2B and other embodiments described herein.

FIG. 4 is an example logic flow diagram illustrating a method of multimodal training and evaluation based on the framework shown in FIGS. 1A-1F, 2A, 2B, and 3, according to some embodiments.

FIGS. 5A-5D provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

### Overview

Advancements in multimodal LLMs have significantly expanded humans' ability to process and interpret complex, multimodal information. Training or evaluating such multimodal LLMs remains challenging due to a scarcity of multimodal training or testing data that simultaneously combining multiple modalities such as images, audios, three-dimensional (3D) point clouds, and videos.

In view of the need for a training/evaluation dataset to train and/or evaluate a multimodal LLM, embodiments described herein provide a data pipeline that generates a dataset of multimodal samples for training and/or evaluating multimodal LLMs. For example, a LLM is used to generate pairs of multimodal samples each including a sample input and a sample output. To generate the sample input, the LLM randomly selects single-modal data samples from multiple different single modal datasets such as a 3D point clouds, audios, images, or videos, and generate a pool of single-modal data samples across multiple modals. The LLM is then used to select a group of single-modal data samples of different modalities, and generate a question associated with the single-modal data samples based on one or more given examples. A sample input is then generated including the question and the plurality of single-modal data samples. The LLM is then provided with examples to generate a sample output that includes an answer to the question and a reasoning of the answer. A dataset, containing a plurality of multimodal samples of (sample input, sample output) pairs, can be generated. The resulted dataset is thus used to train and/or evaluate a multimodal LLM. For example, given a sample input, the multimodal LLM may generate a candidate answer. The candidate answer can thus be compared with a corresponding sample output to train the multimodal LLM.

Embodiments described herein provide a number of benefits. For example, the training/evaluation dataset can more effectively train a multimodal LLM to generate desirable answers conditioned on multimodal input, or more effectively evaluate a multimodal LLM's ability to generate desirable answers based on multimodal input. A chatbot based on a multimodal LLM can then generate answers with improved accuracy in response to a user's query. For example, a chatbot used in healthcare or network issue diagnosis can provide a user answers with improved accuracy. Therefore, with improved performance on multimodal LLM or content generation, neural network technology in implementing AI conversation agents in different practical applications (e.g., healthcare, network diagnostics) are improved.

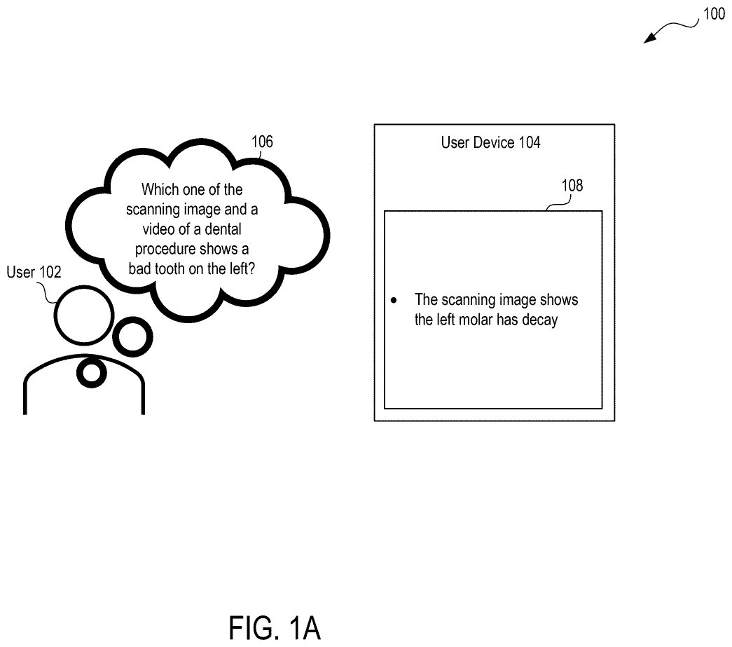

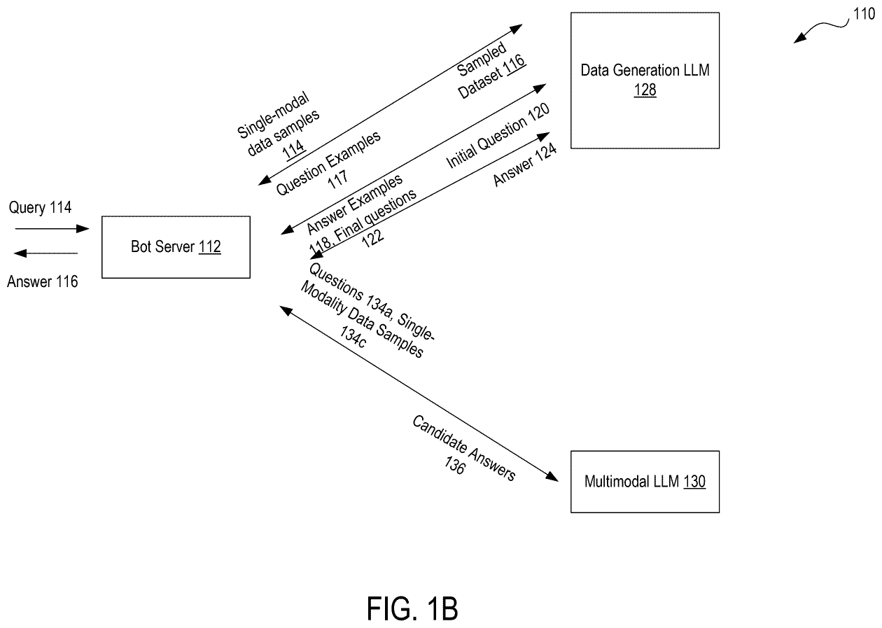

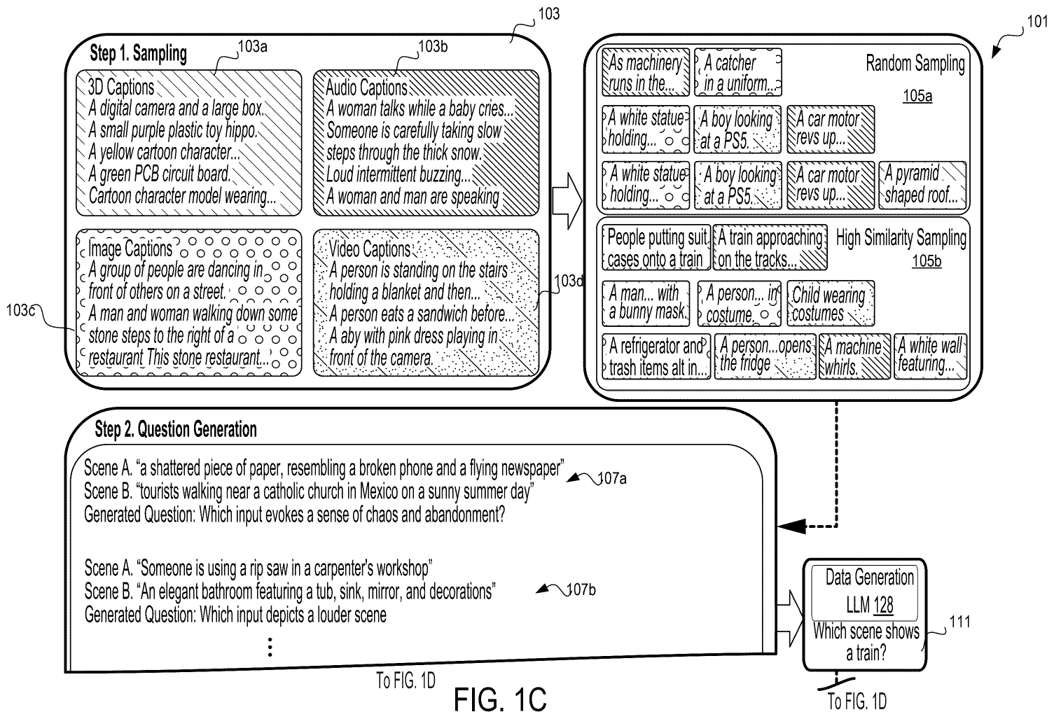

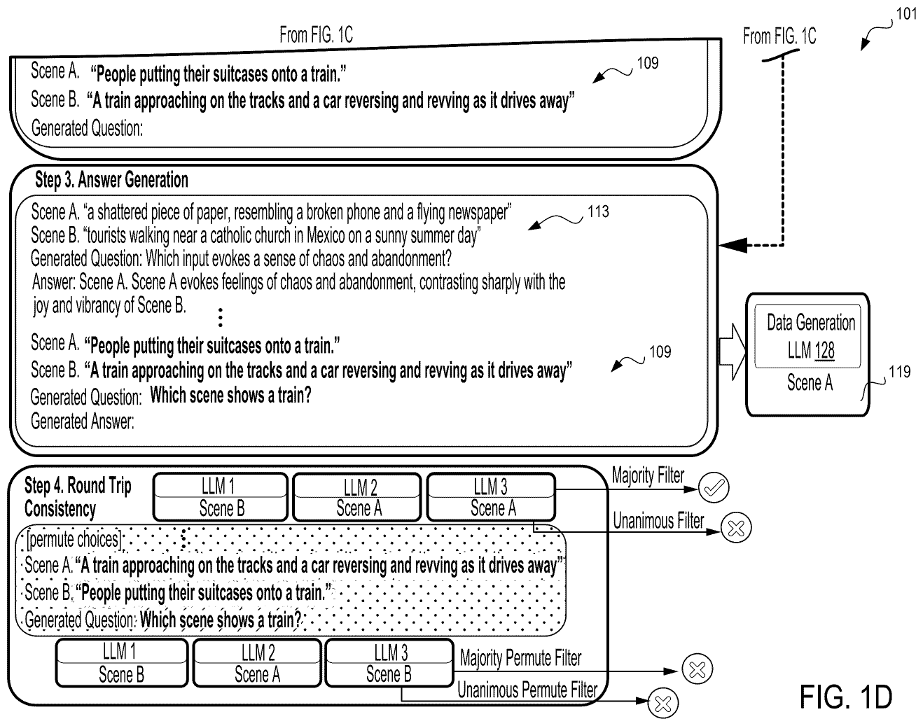

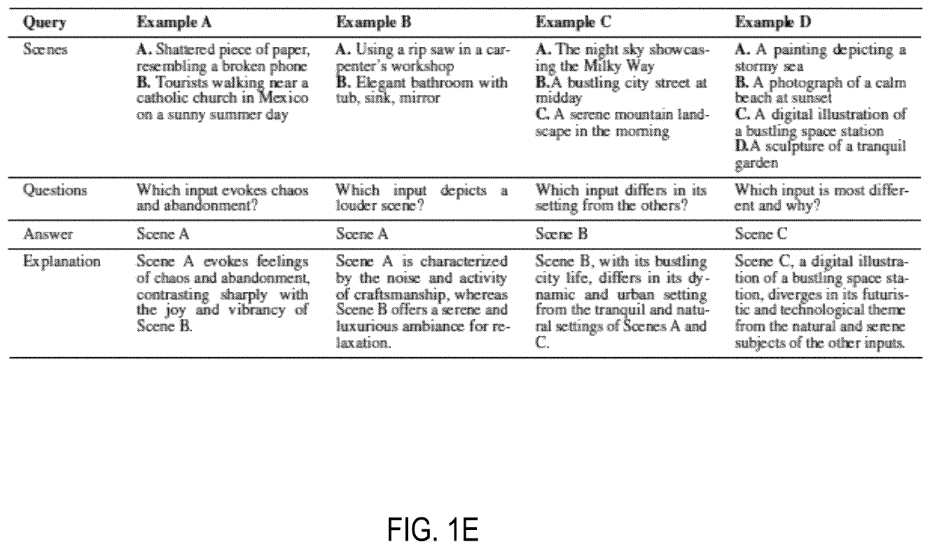

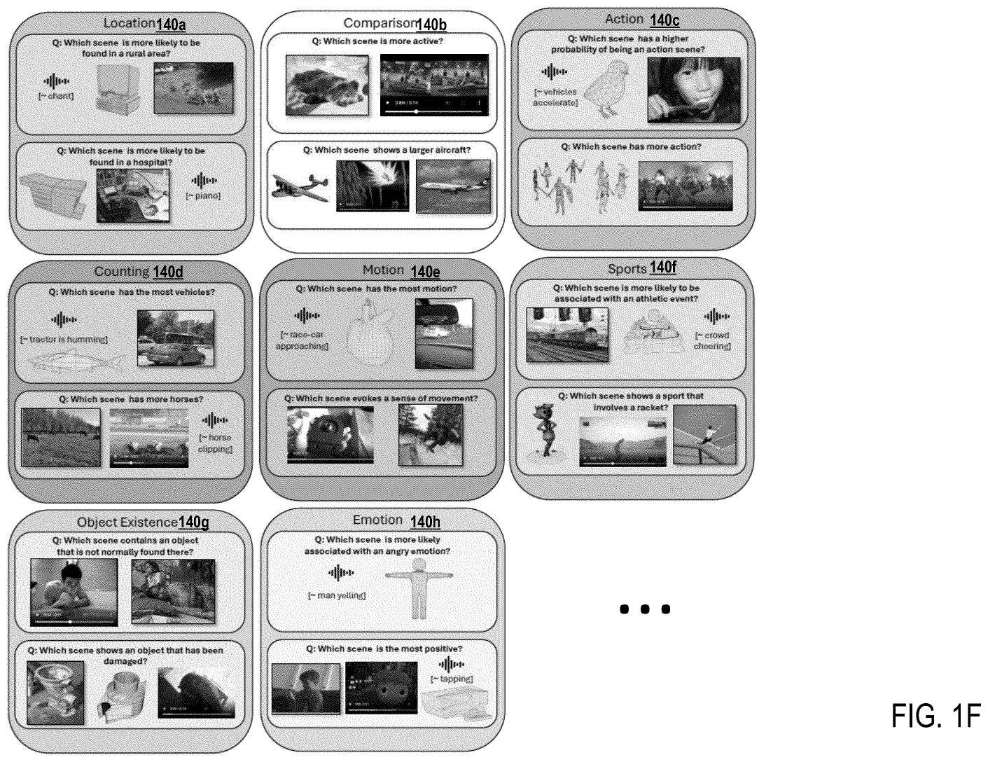

FIG. 1A shows an application 100 of a multimodal LLM, according to embodiments of the present disclosure. A user 102 may utter a query 106 in natural language. In response, a user device 104 may output/display an answer 108 on a display interface, such as a screen. In some embodiments, answer 108 is the output of an AI chatbot (e.g., an AI agent), which is built on a bot server that is communicatively connected to user device 104. The chatbot/AI agent may be based on, or include, a multimodal LLM. In some embodiments, the multimodal LLM receives query 106 through utterance of user 102 as well as multimodal samples as the input, and generate an output based on query 106 and the multimodal samples. In some embodiments, the multimodal samples include natural language description of a mix of single-modal samples of different modalities.

As an example, query 106 may include a question of “Which one of the scanning image and a video of a dental procedure shows a bad tooth on the left?” Query 106 may be a discriminatory question configured to distinguish the samples (e.g., the scanning image and the video) mentioned in query 106 based on their characteristics. Meanwhile, User device 104 may also receive the corresponding scanning image and video, e.g., from user 102's input, download, and/or previous storage. The chatbot may combine query 106 and the uploaded samples in a predefined format providing instruction to the multimodal LLM on how to generate a response to query 106, referred to as a “prompt,” which may be fed to the multimodal LLM as input. The multimodal LLM may in turn provide answer 108 that addresses the question, e.g., selecting one of the samples that satisfies the characteristics mentioned in the question. As an example, answer 108 may be “The scanning image shows the left molar has decay”.

The underlying multimodal LLM may be implemented at user device 104, or at a remote server which is accessible by the user device 104. The multimodal LLM may be trained with a large corpus of texts and/or documents (e.g., multimodal training data) to generate answers that address discriminatory questions regarding the texts and/or documents as further described in FIG. 1B below.

The multimodal LLM may be a pre-trained neural network based language model, and may be evaluated after training. In some embodiments, the training dataset and the evaluation dataset may be generated using the data pipeline, a multimodal training and evaluation framework, provided by this disclosure (detailed description provided as follows). In some embodiments, user device 104 includes suitable hardware and/or software to perform functions of the chatbot. For example, user device 104 may include a processor, a memory, an input interface, and an output interface (detailed description provided as follows). In some embodiments, user device 104 includes a computer or a mobile device such as a mobile phone or a tablet.

FIG. 1B is a simplified diagram illustrating a multimodal training and evaluation framework 110, according to embodiments of the present disclosure. The framework 110 may include a bot server 112 and a data generation LLM 128. Bot server 204 may be operatively connected to a user device 104, data generation LLM 128, and a multimodal LLM 130 through respective application programming interfaces (APIs). In some embodiments, bot server 112 may include a chatbot (e.g., an AI agent) that responds to a user query 114 with an answer 116. In some embodiments, user query 114 includes a multiple-choice question that asks user device 104 (or bot server 112) to make a selection amongst multiple choices in the form of multiple single-modal data samples given in the input prompt. Multimodal training and evaluation framework 110 may be used to generate a training dataset to train multimodal LLM 130, and/or an evaluation dataset to evaluate multimodal LLM 130. FIGS. 1C and 1D show an exemplary process of generating a training/evaluation dataset, which can be divided into non-overlapping portions as a training dataset and an evaluation dataset. FIG. 1D is a continuation of FIG. 1C. FIG. 1E shows certain examples used in the data generation, according to some embodiments. FIG. 1F shows certain examples in the training/evaluation dataset, according to some embodiments. For ease of illustration, FIG. 1B is described in view of FIGS. 1C-1F.

The task performed by data generation LLM 128 may be described in equation (1), which shows the output/answer M(x, q) of data generation LLM 128 conditioned on a concatenation of an input that includes multiple choices of single-modal data samples of different modalities (T(Choiceᵢ)), embedding representations of the modalities

$$( {P}_{m} ( {x}_{m}^{i} ) ) ,$$

and a text query (generated question T(q)). In some embodiments, consider a set

$$X = \{ {X}_{m}^{i} \}$$

comprising N multimodal inputs, where the i'th input

$${X}_{m}^{i}$$

originates from a distinct modality m and is associated with a specific text query q. The function T denotes the tokenization and embedding process employed by data generation LLM 128, and Pₘ is the projection function that transforms inputs from modality m into the data generation LLM 128's linguistic embedding space, and Choiceᵢ corresponds to the enumeration prefix for each input.

$$M ( x , q ) = M ( {⊕}_{i = 1}^{N} ( T ( {Choice}_{i} ) ⊕ {P}_{m} ( {x}_{m}^{i} ) ) ⊕ T ( q ) ) \qquad ( 1 )$$

where ⊕ signifies the operation of concatenation in the embedding space. The objective of the model is to identify which Choice i correctly responds to the query q.

Referring to FIG. 1B, to generate a training/evaluation dataset, bot server 112 may receive a pool 103 of single-modal data samples for data generation LLM 128 to perform a sampling operation. FIG. 1C shows an example of pool 103. Pool 103 may include a plurality of M sets of single-modal data samples. For example, pool 103 may include a set 103a of 3D point cloud samples, a set 103b of audio samples, a set 103c of image samples, and a set 103d of video samples. Sets 103a-103d may each include a plurality of samples of the respective modality. In some embodiments, samples in sets 103a-103d are in the form of respective natural language (e.g., textual) description, which are shown as “captions” in FIG. 1C. Captions of M single-modal data samples may be expressed as D_{M}={(x_{M},c_{M})}, where x represents the single-modal data samples in their respective modalities. The natural language description may serve as a universal connector across various modalities. In some embodiments, a LLM may be used to generate the natural language description of single-modal data samples.

Bot server 112 may transmit an input prompt combining a set of single-modal data samples 114 and an instruction to data generation LLM 128 via the respective API. Set of single-modal data samples 114 may include a plurality of the single-modal data samples of different modalities from pool 103. In some embodiments, set of single-modal data samples 114 includes at least one single-modal data sample from each modality (e.g., 3D point cloud, audio, image, and video) in pool 103. The instruction may cause data generation LLM 128 to select single-modal data samples from set of single-modal data samples 114 and generate a sampled dataset 116, which may include a plurality of subsets, each having single-modal data samples across a plurality of modalities. The single-modal data samples in a subset may describe different scenes. For example, a subset may include a first single-modal data sample of a first modality showing a first scene, a second single-modal data sample of a second modality showing a second scene, etc. In some embodiments, the instruction may cause data generation LLM 128 to select samples using a negative sampling method. In some embodiments, the instruction may cause data generation LLM 128 to categorize subsets based on their contents.

FIG. 1F shows subsets in different categories, 104a, 140b, . . . , 104h, . . . , etc. For example, category 140c (“Action”) may include a subset that includes textual descriptions (or captions) of different scenes, e.g., an audio sample of vehicles accelerate, a 3D point cloud sample of a bird, and a human brushing teeth; category 140d (“Counting”) may include a subset that includes textual descriptions (or captions) of different scenes, e.g., an audio sample of a tractor being humming, a 3D point cloud sample of a fish, and an image of a vehicle, etc.

In various embodiments, data generation LLM 128 may be caused to use at least one of the two negative selection strategies to generate sampled dataset 116. The two negative selection strategies may include a high similarity approach (to select high similarity negative samples) and a random approach (to select random negative samples), to enhance the evaluation potential of the dataset. For the high similarity negative samples approach, all captions across all modalities may first be encoded. Subsequently, one modality is anchored randomly as the basis for selection. From this anchored modality, a negative sample is identified and selected from among a plurality of (e.g., a predetermined number such as about fifty) most similar instances across the different modalities, as ranked by the cosine similarity of their text captions. This selection process results in subsets of two, three, and four different modalities denoted as D_{M}_{ⱼ}[iⱼ], j∈[2 . . . 4] in a subset of sampled dataset 116, where Mⱼ denotes the different modalities in the dataset and iⱼ indexes the selected samples. For the random negative samples approach, the same procedure is performed but single-modal data samples are selected randomly instead by similarity. FIG. 1C shows a sampled dataset 105a resulted from random sampling, and a sampled dataset 105b resulted from high similarity sampling. For example, a subset may include a first single-modal data sample “as machinery runs in the . . . ” of an audio caption and a second single-modal data sample “a catcher in a uniform . . . ” of an image caption. Sampled dataset 114 may include one or both of 105a and 105b. Data generation LLM 128 may transmit sampled dataset 116 to bot server 112.

Upon receiving sampled dataset 116 via the respective API, bot server 112 may transmit an input prompt combining a sampled dataset 116a, a set of question examples 117, and an instruction to data generation LLM 128 via the respective API. Sampled dataset 116a may include one or more single-modal data samples from sampled dataset 116. Set of question examples 117 may include in-context examples that data generation LLM 128 is caused to follow. The instruction may cause data generation LLM 128 to generate an initial question (e.g., a discriminatory question) based on a given subset of multiple choices (e.g., multiple single-modal data samples) following the corresponding question examples. The discriminatory question may select one from the multiple scenes represented by the multiple single-modal data samples. For each subset, data generation LLM 128 may be provided with a predetermined number of (e.g., four) in-context examples, to facilitate the creation of a question q[D_{M}_{ⱼ}[iⱼ], j∈[2 . . . 4]]. FIGS. 1C and 1D show an in-context example 107a, an in-context example 107b, and a subset 109 being transmitted to data generation LLM 128, which follows in-context examples 107a and 107b to generate an initial question 111 “Which scene shows a train?” given subset 109. The subset 109 may include a first single-modal data sample corresponding to “Scene A”, and a second single-modal data sample corresponding to “Scene B,” where the first single-modal data sample has a first modality and the second single-modal data sample has a second modality. Data generation LLM 128 may generate a set of initial questions 120 containing the initial questions (e.g., discriminatory questions) given multiple choices (e.g., multiple single-modal data samples of different scenes) in each of one or more subsets. FIG. 1E shows more in-context examples (e.g., Examples A-D) for question examples.

Upon receiving set of initial questions 120 via the respective API, bot server 112 may perform a filtering process on the initial questions to generate a set of final questions 122. The filtering process may exclude questions that focus on textual qualities rather than the scenes depicted by the modalities. In some embodiments, the filtering process may exclude questions containing terms (and derivatives) that belong to a predefined category that describes textual qualities. For example, the terms may include ‘word’, ‘text’, ‘verb’, ‘noun’, ‘describe’, ‘question’, ‘sentence’, ‘detail’, ‘visual’, ‘image’, ‘video’, ‘audio’, ‘sound’, ‘heard’, ‘3D’, ‘point cloud’, ‘caption’, ‘more elements’, ‘most elements’, ‘more objects’, ‘most objects’, ‘more colors’, ‘most colors’, ‘more than one’, ‘similar’, ‘rating’, ‘score’, etc. In an example, the word-based filtering may reduce set of initial questions 120 of 574 k samples to set of final questions 122 of 239 k samples. In some embodiments, the filtering process improves answer accuracy.

Bot server 112 may transmit an input prompt combining a set of answer examples 118, set of final questions 122, and an instruction to data generation LLM 128. The answer examples 118 may include in-context examples that data generation LLM 128 is caused to follow. The instruction may cause data generation LLM 128 to generate an answer (e.g., a multiple-choice answer M(x, q) of equation (1)) based on a given subset and the corresponding question (from set of final questions 122) following the corresponding answer examples. In some embodiments, the instruction may cause data generation LLM 128 to generate an explanation that includes a reasoning for generating the answer. FIG. 1D shows an in-context example 113 (with a generated question and an answer) and subset 109 (with the corresponding generated question) being transmitted to data generation LLM 128, which follows in-context example 113 to generate an answer 119 “Scene A”. Data generation LLM 128 may generate a set of answers 124 containing the answers corresponding to one or more subsets. In some embodiments, set of answers 124 include one or more explanations corresponding to one or more answers. Data generation LLM 128 may transmit set of answers 124 to bot server 112. FIG. 1E shows more in-context examples (e.g., Examples A-D) for answer examples and explanations.

In some embodiments, the performance of LLM 128 is measured by the accuracy of multiple-choice answers, which is an average of correct multiple-choice answers over all multiple-choice answers, defined as:

$$\begin{matrix}\frac{1}{\vert D \vert} \sum [ M ( x , q ) = a ] , \\ ( x , q , a ) ∈ D\end{matrix} \qquad ( 2 )$$

where D is the dataset of queries (e.g., generated questions by LLM 128). In this open-ended setup, the correct answer can correspond to either the input position (e.g., first, second, . . . ), a label (e.g., A, B, . . . ), or a specific modality m (e.g., audio, image, video, 3D point cloud).

In some embodiments, the reliability of data generation LLM 128 in response to an input across various modalities is measured using a multimodal signal-to-noise ratio (MSNR). Incorporating the complexities of cross-modal models that employ LLMs for prediction, and acknowledging potential biases from the use of LLMs in dataset generation, a novel evaluation metric MSNR is used. This metric adapted from the information-theoretic signal-to-noise ratio (D. H. Johnson. Signal-to-noise ratio, Scholarpedia, 2006) specifically addresses biases inherent in LLMs by quantifying the incremental performance benefits derived from multimodal inputs—considered the ‘signal’—against the backdrop of data generation LLM 128's biases, viewed here as ‘noise’. Specifically, with Sₘ, S₀, and S_{R} representing the data generation LLM 128's outputs (e.g., performance) with multimodal inputs (e.g., a plurality of single-modal data samples of different modalities), caption (no input, e.g., no single-modal data samples), and caption (random input, e.g., a random combination of single-modal data samples other than sampled using the negative or random sampling approaches) respectively. MSN is calculated using the formula:

$$MSNR = \frac{{S}_{m} - mean ( {S}_{0} {S}_{r} )}{mean ( {S}_{0} {S}_{r} )} \qquad ( 3 )$$

Bot server 112 may generate/assemble a training/evaluation dataset 132 including one or more questions 122a from set of final questions 122, one or more corresponding answers 124a from set of answers 124, and one or more subsets of single-modal data samples 126 selected from sampled dataset 116a and corresponding to the one or more questions 122a, forming a set of (sample input, sample output) pairs for multimodal LLM 130. In some embodiments, a sample input may include a subset of single-modal data sample and a corresponding question, and a sample output may include the corresponding answer. In some embodiments, bot server 112 may divide training/evaluation dataset 132 into a training dataset 134 and an evaluation dataset 136, which are non-overlapping to each other. For example, training dataset 134 may be a majority portion (e.g., about 80%) of training/evaluation dataset 132, and evaluation dataset 136 may be a minority portion (e.g., about 20%) of training/evaluation dataset 132.

In some embodiments, to reduce “selection bias,” as detailed in (P. Pezeshkpour and E. Hruschka. Large language models sensitivity to the order of options in multiple-choice questions, 2023; N. Balepur, A. Ravichander, and R. Rudinger, Artifacts or abduction: How do llms answer multiple-choice questions without the question? 2024; X. Wang, B. Ma, C. Hu, L. Weber-Genzel, P. Rottger, F. Kreuter, D. Hovy, and B. Plank, “my answer is c”: First-token probabilities do not match text answers in instruction-tuned language models, 2024), which highlights the LLM's vulnerability to multiple choice option perturbations, training/evaluation dataset 132 is filtered using a round-trip-consistency (RTC) check to remove subsets (and/or corresponding questions and answers) that do not result in consistent answers and explanation in different LLMs. By selecting those subsets (and corresponding questions and answers) that demonstrate robustness under choices permutations, the data generation LLM 128's inherent bias towards specific options can be controlled, thereby increasing the overall correctness of the resulted training/evaluation dataset 132. A subset (and/or corresponding question and answer) may be retained if it meets one or more filtering criteria. A majority filter refers to that the majority of the LLMs have the same answer and explanation, while an unanimous filter refers to that all the LLMs have the same answer. As shown in FIG. 1D, a subset and its corresponding question (e.g., 109) in training/evaluation dataset 132 may be provided to various different LLMs (e.g., LLM1, LLM2, and LLM3) by bot server 112 via respective APIs. Bot server 112 may receive the answers from each LLM (e.g., “Scene B” by LLM1, “Scene A” by LLM2, and “Scene A” by LLM3), and determine whether the subset (and its corresponding question and answer) can be retained. In various embodiments, different filtering methods can be used to filter the answers. For example, if bot server 112 uses the majority filter, in which the majority (e.g., 2 out of 3) of LLMs are required to provide the same answer, the subset retains. If bot server uses the unanimous filter, in which all (e.g., 3 out of 3) of LLM are required to provide the same answer, the subset is removed. In some embodiments, to ensure minimal randomness and maximize the likelihood of response convergence, the LLMs employ greedy decoding with a temperature setting of 0.1 during this process.

Alternatively or additionally, in some embodiments, the order/permutation of the single-modal data samples in the subset is changed when provided to different LLMs. For example, instead of provided with an order of “Scene A” followed by “Scene B” for subset, the LLMs may be provided with “Scene B” followed by “Scene A,” before the corresponding question is provided. Bot server 112 may receive the answers from each LLM (e.g., “Scene B” by LLM1, “Scene A” by LLM2, and “Scene B” by LLM3), and determine whether the subset (and its corresponding question and answer) can be retained. For example, if bot server 112 uses a majority filter, in which the majority (e.g., 2 out of 3) of LLMs are required to provide the same answer, the subset is removed. If bot server uses a unanimous filter, in which all (e.g., 3 out of 3) of LLM are required to provide the same answer, the subset is also removed. In some embodiments, if the subset includes at least three scenes, all permutations/orders may be evaluated. In various, the subsets (and the corresponding questions and answers) may be retained if they satisfy one or more criteria, e.g., before and/or after the permutation.

Bot server 112 may train multimodal LLM 130 using the training dataset 134, as shown in FIG. 1B. In some embodiments, training dataset 134 may include one or more questions 134a, one or more answers 134b corresponding to the one or more questions 134a, and one or more subsets of single-modal data samples 134c corresponding to the one or more questions 134a. In some embodiments, each of one or more subsets of single-modal data samples 134c may include single-modal data samples of different modalities, and may represent a different scene. In some embodiments, bot server 112 may transmit one or more questions 134a and the corresponding one or more subsets of single-modality samples 134c as input to multimodal LLM 130 via the respective API to multimodal LLM 130, which generates one or more candidate answers 136, each conditioned on a respective question and a concatenation of respective single-modal data samples in the respective subset. Multimodal LLM 130 may be trained on the training dataset 134 based on a training objective comparing candidate answers 136 and answers 134b. The training objective may include a loss function, e.g., a cross entropy, a minimum mean squared error (MMSE), or a combination. During the training, the parameters of multimodal LLM 130 may be updated to minimize the training objective.

Bot server 112 may evaluate multimodal LLM 130 using the evaluation dataset 136 after the training, and may finetune the parameters of multimodal LLM 130. In inference stage, bot server 112 may receive a query 114 from a user by the user's utterance. The query 114 may include a discriminatory question concerning a plurality of scenes described by a plurality of single-modal data samples (e.g., one or more images, one or more videos, one or more 3D point clouds, and/or one or more audios). Bot server 112 may obtain the single-modal data samples from downloading from one or more sources or from a local memory. Bot server 112 may transmit the single-modal data samples and query 114 to multimodal LLM 130 to generate an answer 116, which is returned by multimodal LLM 130 and shown to the user by bot server 112.

In an embodiment, bot server 112 may be implemented as part of an autonomous driving system. Bot server 112 and/or the autonomous system may have access or receive a plurality of single-modal data samples such as real-time images of a surrounding of the autonomous driving system, and videos of surroundings of the autonomous driving system. The autonomous system may receive a task request from a user, such as a of “how to get to the nearest hospital?” The autonomous driving system may generate a navigational request that includes a discriminatory question such as “which scene shows a route to the nearest hospital?” Bot server 112 may sample single-modal data samples of different modalities from the plurality of single-modal data samples, and generate a response based on one or more groups of single-modal data samples such as “Scene A in video B.” The response may cause the autonomous driving system to generate one or more control commands, which are sent and executed by the autonomous driving system based on the response.

### Computer and Network Environment

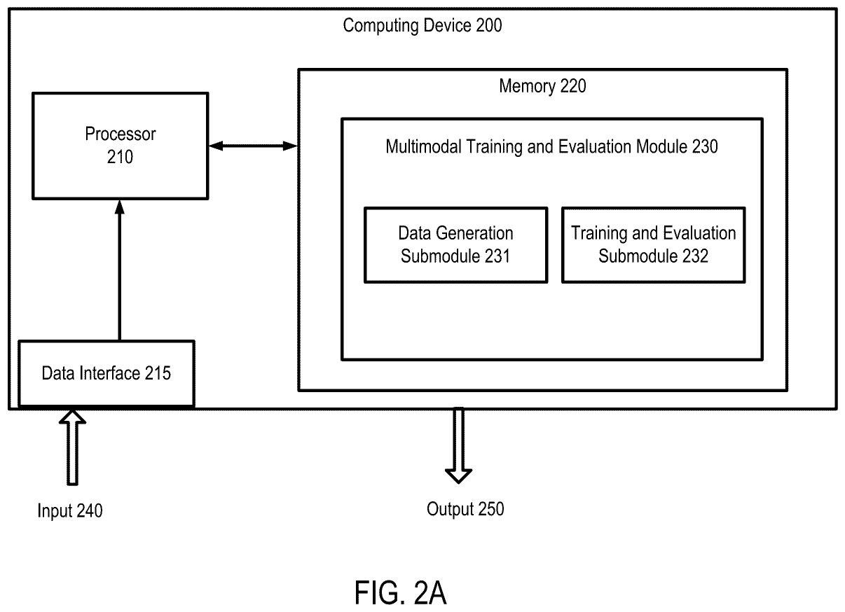

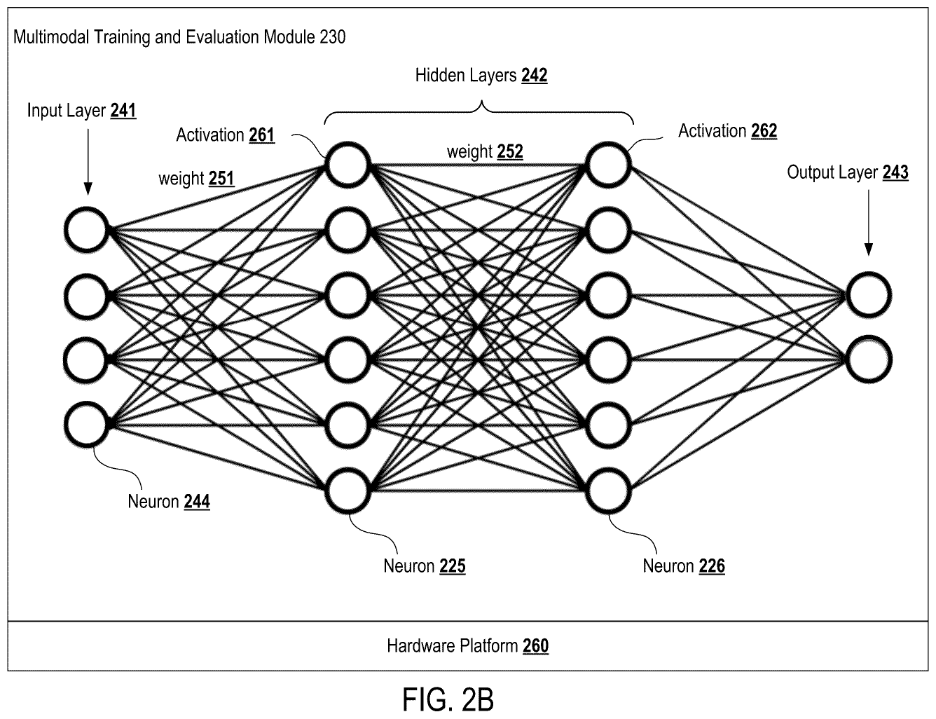

FIG. 2A is a simplified diagram illustrating a computing device implementing the multimodal training and evaluation framework 110 described in FIGS. 1A-1F according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In another embodiment, processor 210 may comprise multiple microprocessors and/or memory 220 may comprise multiple registers and/or other memory elements such that processor 210 and/or memory 220 may be arranged in the form of a hardware-based neural network, as further described in FIG. 2B.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for multimodal training and evaluation module 230 that may be used to implement and/or emulate the systems and models, and/or to implement any of the methods described further herein multimodal training and evaluation module 230 may receive input 240 such as an input training data (e.g., subsets and corresponding questions and answers) via the data interface 215 and generate an output 250 which may be candidate answers.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as subsets and corresponding questions and answers, from a user via the user interface.

In some embodiments, the multimodal training and evaluation module 230 is configured to generate training and/or evaluation datasets, and train and/or evaluate a multimodal LLM using the generated training and/or evaluation datasets. The multimodal training and evaluation module 230 may further include a data generation submodule 231 and a training evaluation submodule 232. Submodules 231 and 232 may perform similar operations as bot server 112 in FIG. 1B. Data generation submodule 231 may be configured to generate a training dataset (e.g., 134) and optionally an evaluation dataset 136 used for training and evaluating a multimodal LLM (e.g., 130). In some embodiments, Data generation submodule 231 may communicate with and cause a data generation LLM (e.g., 128) to generate a training/evaluation dataset (e.g., 132) that includes a plurality of subsets of single-modal data samples of different modalities, a plurality of corresponding questions, and a plurality of answers. In some embodiments, data generation submodule 231 may filter out subsets and their corresponding questions and answers that do not meet the RTC criteria. In some embodiments, data generation submodule 231 may evaluate the output/performance of the data generation LLM by calculating its accuracy of multiple-choice answers (e.g., equation (2)) and a MSNR (e.g., equation (3)). In some embodiments, data generation submodule 231 may divide the training/evaluation dataset into a training dataset (e.g., 134) and an evaluation dataset (e.g., 136). Training and evaluation submodule 232 may train a multimodal LLM (e.g., 130) using the training dataset and/or evaluating the multimodal LLM using the evaluation dataset.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 2B is a simplified diagram illustrating the neural network structure implementing the multimodal training and evaluation module 230 described in FIG. 2A, according to some embodiments. In some embodiments, the multimodal training and evaluation module 230 and/or one or more of its submodules 231 and 232 may be implemented at least partially via an artificial neural network structure shown in FIG. 2B. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2A), such as a plurality of subsets and their corresponding questions. The number of nodes (neurons) in the input layer 241 may be determined by the dimensionality of the input data (e.g., the length of a vector of a plurality of subsets and their corresponding questions). Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2A, the multimodal training and evaluation module 230 receives an input 240 of a plurality of subsets and their corresponding questions and transforms the input into an output 250 of candidate answers. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the multimodal training and evaluation module 230 and/or one or more of its submodules 231 and 232 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be GPT-4, LLaMa, Mistral, Flan-T5, and/or the like.

In one embodiment, the multimodal training and evaluation module 230 and its submodules 231 an d232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the multimodal training and evaluation module 230 and its submodules 231 and 232 may be implemented by hardware, software and/or a combination thereof. For example, the multimodal training and evaluation module 230 and its submodules 231 and 232 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In another embodiment, some or all of layers 241, 242, 243 and/or neurons 242, 245, 246, and operations there between such as activations 261, 262, and/or the like, of the multimodal training and evaluation module 230 and its submodules 231 and 232 may be realized via one or more ASICs. For example, each neuron 242, 245 and 246 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICS.

For example, the multimodal training and evaluation module 230 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based multimodal training and evaluation module 230 and one or more of its submodules 231 and 232 may be trained by iteratively updating the underlying parameters (e.g., weights 251, 252, etc., bias parameters and/or coefficients in the activation functions 261, 262 associated with neurons) of the neural network based on a loss. For example, during forward propagation, the training data such as subsets and the corresponding questions are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth” such as the corresponding correct answers generated by the data generation LLM) from the training data, to compute a loss function that measures the discrepancy between the predicted output and the expected output. For example, the loss function may be, e.g., cross entropy, and/or MMSE. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

In one embodiment, the neural network based multimodal training and evaluation module 230 and one or more of its submodules 231 and 232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

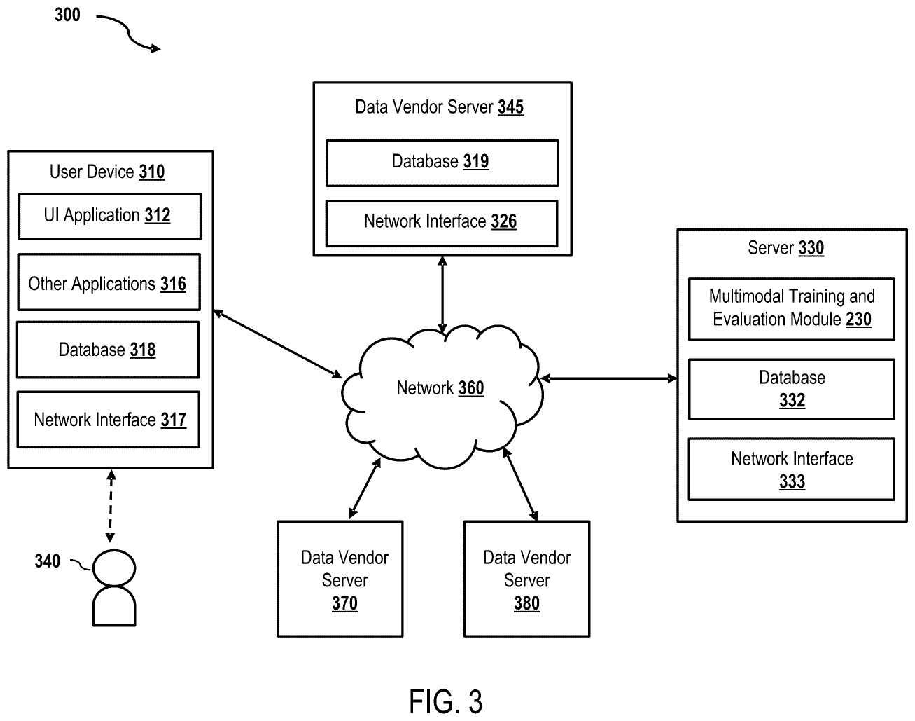

In one embodiment, multimodal training and evaluation module 230 and its submodules 231 and 232 may be housed at a centralized server (e.g., computing device 200) or one or more distributed servers. For example, one or more of multimodal training and evaluation module 230 and its submodules 231 and 232 may be housed at external server(s). The different modules may be communicatively coupled by building one or more connections through application programming interfaces (APIs) for each respective module. Additional network environment for the distributed servers hosting different modules and/or submodules may be discussed in FIG. 3.

During a backward pass, parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an answer in response to an input containing a query (e.g., a multiple-choice question) from a user's utterance and a plurality of single-modal data samples of different modalities.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in cross-modal reasoning.

FIG. 3 is a simplified block diagram of a networked system 300 suitable for implementing the multimodal training and evaluation framework 110 described in FIGS. 1A-1F, 2A, and 2B and other embodiments described herein. In one embodiment, system 300 includes the user device 310 which may be operated by user 340, data vendor servers 345, 370 and 380, server 330, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 3 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 310, data vendor servers 345, 370 and 380, and the server 330 may communicate with each other over a network 360. User device 310 may be utilized by a user 340 (e.g., a driver, a system admin, etc.) to access the various features available for user device 310, which may include processes and/or applications associated with the server 330 to receive an output data anomaly report.

User device 310, data vendor server 345, and the server 330 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

User device 310 may be implemented as a communication device that may utilize appropriate hardware and software configured for wired and/or wireless communication with data vendor server 345 and/or the server 330. For example, in one embodiment, user device 310 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 310 of FIG. 3 contains a user interface (UI) application 312, and/or other applications 316, which may correspond to executable processes, procedures, and/or applications with associated hardware. For example, the user device 310 may receive a message indicating an answer (e.g., a candidate answer) from the server 330 and display the message via the UI application 312. In other embodiments, user device 310 may include additional or different modules having specialized hardware and/or software as required.

In one embodiment, UI application 312 may communicatively and interactively generate a UI for an AI agent implemented through the multimodal training and evaluation module 230 (e.g., an LLM agent) at server 330. In at least one embodiment, a user operating user device 310 may enter a user utterance, e.g., via text or audio input, such as a question, uploading a document, and/or the like via the UI application 312. Such user utterance may be sent to server 330, at which multimodal training and evaluation module 230 may generate a response via the process described in FIGS. 1A-1F, 2A, and 2B. The multimodal training and evaluation module 230 may thus cause a display of an answer to a multiple-choice question at UI application 312 and interactively update the display in real time with the user utterance.

In various embodiments, user device 310 includes other applications 316 as may be desired in particular embodiments to provide features to user device 310. For example, other applications 316 may include security applications for implementing client-side security features, programmatic client applications for interfacing with appropriate application programming interfaces (APIs) over network 360, or other types of applications. Other applications 316 may also include communication applications, such as email, texting, voice, social networking, and IM applications that allow a user to send and receive emails, calls, texts, and other notifications through network 360. For example, the other application 316 may be an email or instant messaging application that receives a prediction result message from the server 330. Other applications 316 may include device interfaces and other display modules that may receive input and/or output information. For example, other applications 316 may contain software programs for asset management, executable by a processor, including a graphical user interface (GUI) configured to provide an interface to the user 340 to view an answer to a multiple-choice question.

User device 310 may further include database 318 stored in a transitory and/or non-transitory memory of user device 310, which may store various applications and data and be utilized during execution of various modules of user device 310. Database 318 may store user profile relating to the user 340, predictions previously viewed or saved by the user 340, historical data received from the server 330, and/or the like. In some embodiments, database 318 may be local to user device 310. However, in other embodiments, database 318 may be external to user device 310 and accessible by user device 310, including cloud storage systems and/or databases that are accessible over network 360.

User device 310 includes at least one network interface component 317 adapted to communicate with data vendor server 345 and/or the server 330. In various embodiments, network interface component 317 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 345 may correspond to a server that hosts database 319 to provide training datasets including a plurality of subsets, and the corresponding questions and answers to the server 330. The database 319 may be implemented by one or more relational database, distributed databases, cloud databases, and/or the like.

The data vendor server 345 includes at least one network interface component 326 adapted to communicate with user device 310 and/or the server 330. In various embodiments, network interface component 326 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 345 may send asset information from the database 319, via the network interface 326, to the server 330.

The server 330 may be housed with the multimodal training and evaluation module 230 and its submodules described in FIG. 2A. In some implementations, multimodal training and evaluation module 230 may receive data from database 319 at the data vendor server 345 via the network 360 to generate a candidate answer. The generated candidate answer may also be sent to the user device 310 for review by the user 340 via the network 360.

The database 332 may be stored in a transitory and/or non-transitory memory of the server 330. In one implementation, the database 332 may store data obtained from the data vendor server 345. In one implementation, the database 332 may store parameters of the multimodal training and evaluation module 230. In one implementation, the database 332 may store previously generated answers (and/or questions), and the corresponding input feature vectors.

In some embodiments, database 332 may be local to the server 330. However, in other embodiments, database 332 may be external to the server 330 and accessible by the server 330, including cloud storage systems and/or databases that are accessible over network 360.

The server 330 includes at least one network interface component 333 adapted to communicate with user device 310 and/or data vendor servers 345, 370 or 380 over network 360. In various embodiments, network interface component 333 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 360 may be implemented as a single network or a combination of multiple networks. For example, in various embodiments, network 360 may include the Internet or one or more intranets, landline networks, wireless networks, and/or other appropriate types of networks. Thus, network 360 may correspond to small scale communication networks, such as a private or local area network, or a larger scale network, such as a wide area network or the Internet, accessible by the various components of system 300.

### Example Work Flows

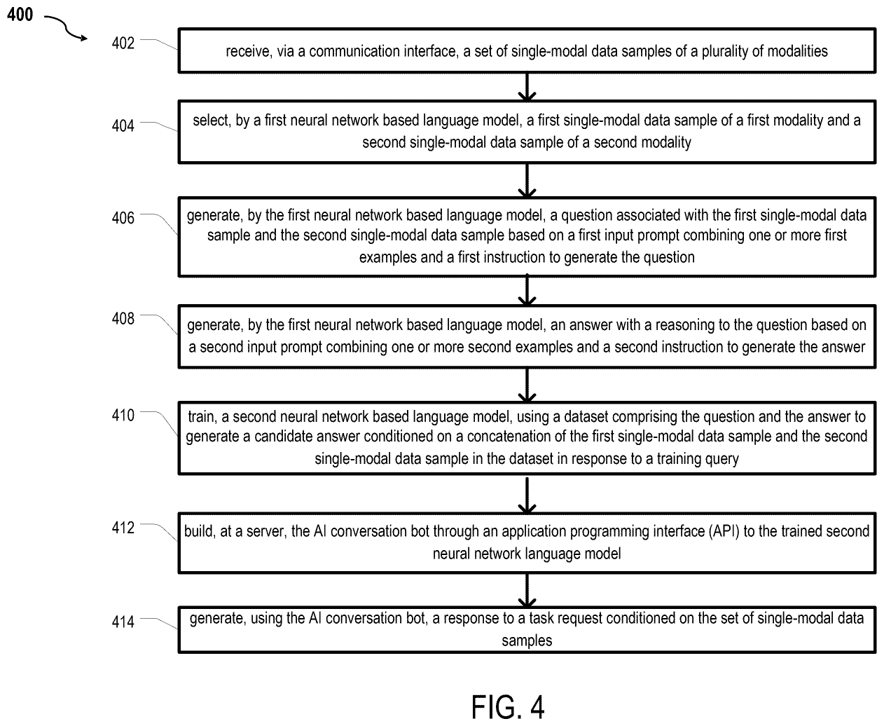

FIG. 4 is an example logic flow diagram illustrating a method of building an AI agent to respond to a task query from a user using the multimodal training and evaluation framework shown in FIGS. 1A-1F, 2A, 2B, and 3, according to some embodiments described herein. One or more of the processes of method 400 may be implemented, at least in part, in the form of executable code stored on non-transitory, tangible, machine-readable media that when run by one or more processors may cause the one or more processors to perform one or more of the processes. In some embodiments, method 400 corresponds to the operation of the multimodal training and evaluation module 230 (e.g., FIGS. 2A and 3) that performs generating a response to a user's task request.

As illustrated, the method 400 includes a number of enumerated steps, but aspects of the method 400 may include additional steps before, after, and in between the enumerated steps. In some aspects, one or more of the enumerated steps may be omitted or performed in a different order.

At step 402, a set of single-modal data samples of a plurality of modalities are received via a communication interface.

At step 404, a first single-modal data sample of a first modality and a second single-modal data sample of a second modality are selected by a first neural network based language model.

In some embodiments, the first single-modal data sample comprises a natural language description of a first scene, and the second single-modal data sample comprises a natural language description of a second scene, and the first modality and the second modality comprise an audio, an image, a video, or a three-dimensional (3D) point cloud.

In some embodiments, the first single-modal data sample and the second single-modal data sample are selected based on a similarity between the first single-modal data sample and the second single-modal data sample or randomness.

At step 406, a question associated with the first single-modal data sample and the second single-modal data sample is generated by the first neural network based language model, based on a first input prompt combining one or more first examples and a first instruction to generate the question.

In some embodiments, the question comprises a discriminatory question between the first scene and the second scene. In some embodiments, method 400 further includes filtering out the question in response to the question including one or more terms describing textual qualities.

At step 408, an answer with a reasoning to the question is generated by the first neural network based language model based on a second input prompt combining one or more second examples and a second instruction to generate the answer.

In some embodiments, method 400 further includes evaluating an accuracy of the answer by computing an accuracy metric based on an order of the first single-modal data sample and the second single-modal data sample, a label of the first single-modal data sample and the second single-modal data sample, or types of modalities of the first single-modal data sample and the second single-modal data sample.

In some embodiments, method 400 further includes evaluating a quality of the question and the answer by: determining a first performance value of the first neural network based language model in response to a first evaluation input prompt combining single-modal data samples of a plurality modalities with an evaluation question associated with the single-modal data samples; determining a mean value of a second performance value of the second neural network based language model in response to a second evaluation input prompt combining the evaluation question without the single-modal data samples and a third performance value of the first neural network based language model in response to a third evaluation input prompt combining the evaluation question with random single-modal data samples; and computing a multimodal signal-to-noise ratio (MSNR) based on a ratio of a difference between the first performance value and the mean value over the mean value.

At step 410, a second neural network based language model is trained using a dataset comprising the question and the answer to generate a candidate answer conditioned on a concatenation of the first single-modal data sample and the second single-modal data sample in the dataset in response to a training query;

At step 412, the AI conversation bot is built at a server, through an application programming interface (API) to the trained second neural network language model.

At step 414, a response to the task request is generated, using the AI conversation bot conditioned on the set of single-modal data samples.

In some embodiments, the task request comprises a navigational request from an autonomous driving system, and the set of single-modal data samples comprises one or more real-time images of surroundings of the autonomous driving system and one or more videos of the surroundings of the autonomous driving system, and the method further comprises causing one or more control commands to be sent and executed by the autonomous driving system based on the response.

In some embodiments, method 400 further includes: generating, by one or more third neural network based language models, second candidate answers with reasoning in response to a third input prompt combining the first single-modal data sample, the second single-modal data sample, and the question; retaining the dataset in response to a percentage of the second candidate answers being consistent with the candidate answer exceeding a predetermined value; and disregarding the dataset in response to the percentage of the second candidate answers being consistent with the candidate answer being below the predetermined value. In some embodiments, method 400 further includes changing an order of the first single-modal data sample and the second single-modal data sample.

In one embodiment, method 400 is applicable in a variety of applications. For example, the task request received by a neural network model (e.g., multimodal LLM 130) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 400, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 400 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

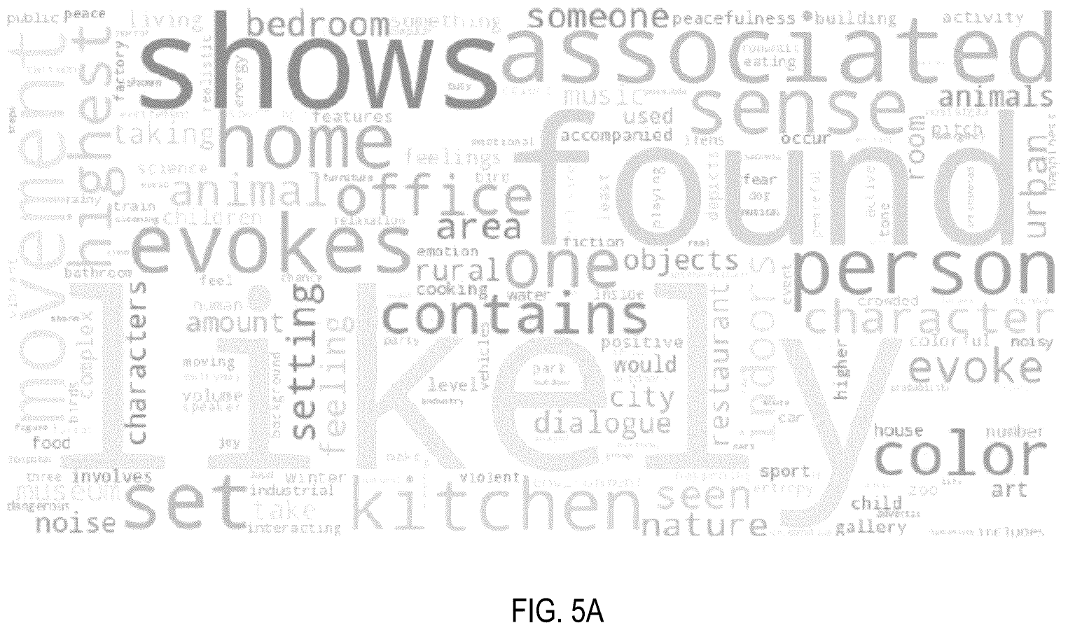

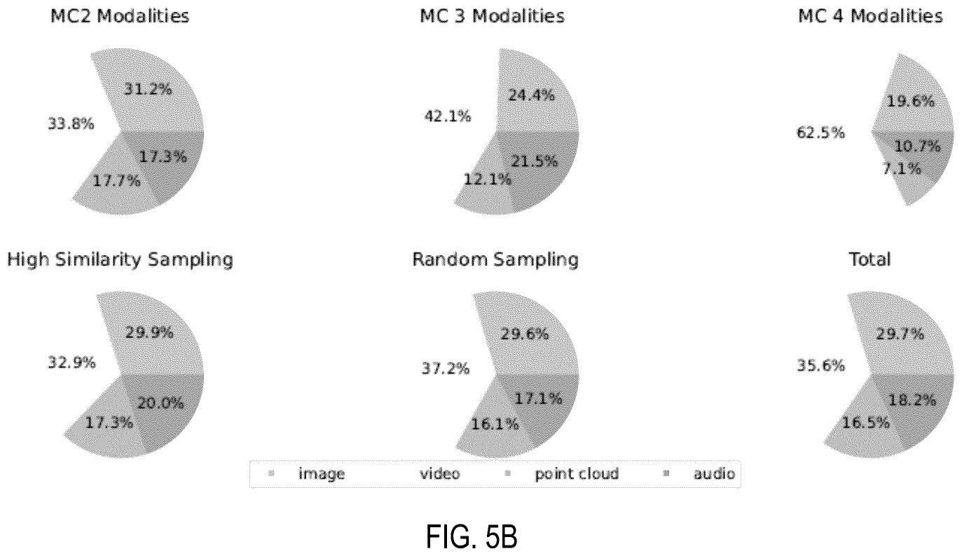

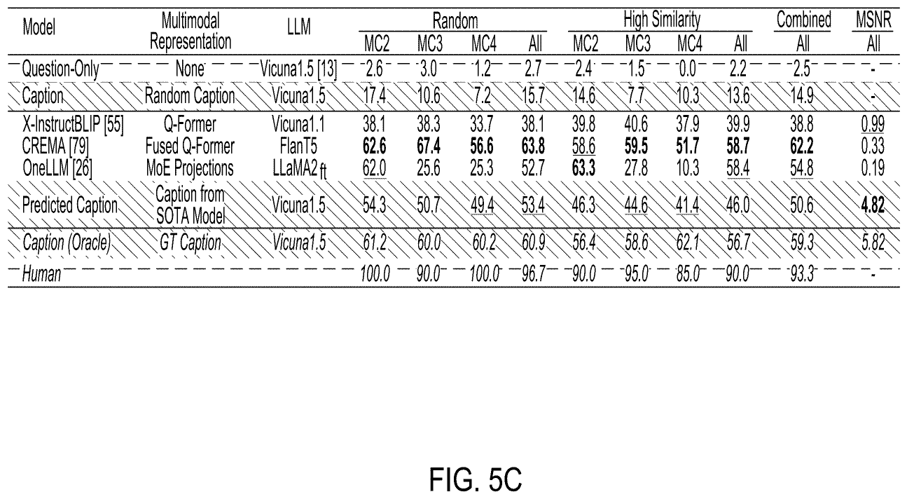

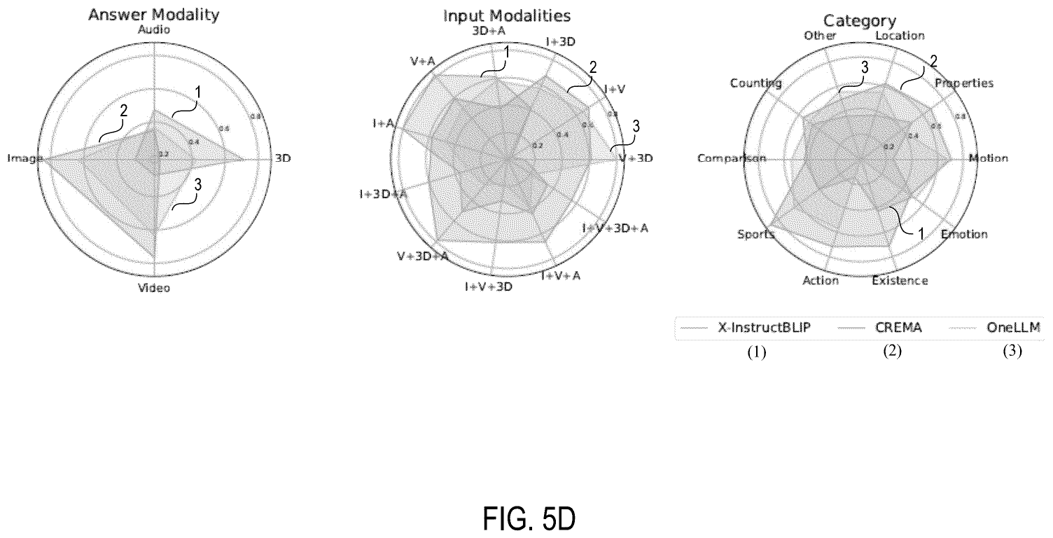

FIGS. 5A-5D represent exemplary test results using embodiments described herein.

To generate the data, the Hugging Face implementation of LLaMA-2 13b (G. Team, R. Anil, S. Borgeaud, Y. Wu, J.-B. Alayrac, J. Yu, R. Soricut, J. Schalkwyk, A. M. Dai, A. Hauth, et al., Gemini: a family of highly capable multimodal models, 2023.) with code meta-llama/Llama-2-13b-hfquantized in 4-bit using BitsAndBytes is employed. All generation is completed in a single A100 40 GB GPU using the default generation parameters with the exception of temperature which is set to 0.4 and repetition penalty set to 1.1 to generate diverse completions. For the round-trip-consistency check, LLAMA-2 13b Chat, Mistral 7b-Instruct v2 (A. Q. Jiang, A. Sablayrolles, A. Mensch, C. Bamford, D. S. Chaplot, D. d. l. Casas, F. Bressand, 377 G. Lengyel, G. Lample, L. Saulnier, et al., Mistral 7b., 2023), and Flan-T5xxl (S. Longpre, L. Hou, T. Vu, A. Webson, H. W. Chung, Y. Tay, D. Zhou, Q. V. Le, B. Zoph, J. Wei, 421 et al., The flan collection: Designing data and methods for effective instruction tuning.) are employed. For the permutation checks, all possible permutations of the answer choices are considered. For the text similarity, cosine similarity with the sentence-transformersall-MiniLM-L6-v2 model encodings implementation is used.

The training/evaluation dataset introduced in this disclosure comprises 65.5 k distinct single-modal data samples, featuring a total of 10.6 k distinct questions of average length 9.5 tokens over a vocabulary of size 2.6 k. FIG. 5A presents a word cloud of the most common words in the dataset, excluding terms like “which scene” that appear in all samples and stopwords from nltk.stopwords. All samples are post-processed to ensure a balanced distribution of answers across different subsets of the dataset; specifically there is a balance between answers A and B among randomly sampled questions with two modalities, between high-similarity sampled questions with three modalities, and so forth. FIG. 5B illustrates the distribution of the answer modality across different subsets of the dataset.

To validate the difficulty of the task and present the dataset as a challenge to the community, a collection of state-of-the-art models capable of handling all four modalities presented in the dataset are evaluated. Additionally, LLM-only-based variants that utilize various forms of captions (predicted, random, empty, or oracle) to make their predictions are assessed. Specifically, No Input is an LLM-only baseline where the LLM must make a selection without providing any non-linguistic inputs or scene descriptions. Caption (Random) is an LLM-only baseline that randomly samples a caption from the caption pool of the training/evaluation dataset to represent each multimodal input. Caption (Predicted) is an LLM-only baseline that uses predicted captions from multimodal models to replace the multimodal scenes. This baseline employs InstructBLIP (W. Dai, J. Li, D. Li, A. Tiong, J. Zhao, W. Wang, B. Li, P. Fung, and S. Hoi, InstructBLIP: Towards general-purpose vision-language models with instruction tuning, In Thirty-seventh Conference on Neural Information Processing Systems, 2023) to generate captions for images and videos, Pengi (S. Deshmukh, B. Elizalde, R. Singh, and H. Wang, Pengi: An audio language model for audio tasks, In Thirty-seventh Conference on Neural Information Processing Systems, 2023) for audio, and X-InstructBLIP (A. Panagopoulou, L. Xue, N. Yu, J. Li, D. Li, S. Joty, R. Xu, S. Savarese, C. Xiong, and J. C. Niebles, X-instructblip: A framework for aligning x-modal instruction-aware representations to Ilms and emergent cross-modal reasoning, 2023) for 3D point clouds. Finally, Caption (Oracle) uses ground truth captions and an LLM other than those used to generate and filter the dataset for making predictions. In terms of multimodal models, two models that maintain a frozen LLM and separate encoders for each modality, X-InstructBLIP (A. Panagopoulou, L. Xue, N. Yu, J. Li, D. Li, S. Joty, R. Xu, S. Savarese, C. Xiong, and J. C. Niebles, X-instructblip: A framework for aligning x-modal instruction-aware representations to Ilms and emergent cross-modal reasoning, 2023), and CREMA (S. Yu, J. Yoon, and M. Bansal. Crema: Multimodal compositional video reasoning via efficient modular adaptation and fusion. arXiv preprint arXiv:2402.05889, 2024), are verified, with their main distinction being that the latter uses a fused Q-Former to align modalities to language, whereas the former maintains separate Q-Formers for each modality. OneLLM (J. Han, K. Gong, Y. Zhang, J. Wang, K. Zhang, D. Lin, Y. Qiao, P. Gao, and X. Yue. Onellm: One framework to align all modalities with language, 2023) which maintains a common encoding space and fused modality to the LLM connector and trains the entire architecture, including the LLM, is also evaluated.

Each model is prompted with a prompt tailored to align with those used in similar multiple-choice or question-answering tasks in official evaluations. Generally, the question is formatted as “{features A} {features B} [ . . . ] {Question}. Select from the choices: Scene A, Scene B [ . . . ] Answer:”

Results: The results for each baseline model are summarized in FIG. 5C. It is evident that all models struggle with the dataset, as they fail to reach the human performance benchmark of 93.3% accuracy even with Oracle captions. While CREMA emerges as the top-performing model overall, it exhibits a lower MSNR compared to both X-InstructBLIP and Caption (Predicted). This discrepancy suggests that some of the advantages observed in CREMA may be attributed to the underlying LLM, which appears to perform better on this task, irrespective of multimodal inputs likely due to the use of a model from the same model family in the data filtering process. Moreover, although OneLLM generally outperforms X-InstructBLIP, it exhibits weaker results in scenarios requiring the integration of more than two modalities. Similarly, there seems to be a pattern of worse performance in the cases where more than two modalities are present, and there is high similarity sampling compared to random despite the seemingly comparable performance in the overall dataset.

Model performance is further broken down based on answer modality, input modalities, and category type in FIG. 5D. It is found that CREMA and OneLLM perform better than X-InstructBLIP when the answer is a visual modality (image or video), while the opposite is true in when the answer is audio or 3D. In terms of input modalities, OneLLM shows superior performance in Video and 3D inputs but poorer performance in all other combinations. It is found that X-InstructBLIP shows very poor results on image and video inputs, likely due to the video projection being initialized from the image projection and only trained for few iterations, leading the hard differentiation across modalities. In terms of categories, it seems that all models struggle with comparison and emotions, while OneLLM fails on existence questions, and X-InstructBLIP on questions regarding action and motion, likely due to its training data distribution.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of building an artificial intelligence (AI) agent to respond to a task request from a user, comprising:
receiving, via a communication interface, a set of single-modal data samples of a plurality of modalities;
selecting, by a first neural network based language model, a first single-modal data sample of a first modality and a second single-modal data sample of a second modality;
generating, by the first neural network based language model, a question associated with the first single-modal data sample and the second single-modal data sample based on a first input prompt combining one or more first examples and a first instruction to generate the question;
generating, by the first neural network based language model, an answer with a reasoning to the question based on a second input prompt combining one or more second examples and a second instruction to generate the answer;
training, a second neural network based language model, using a dataset comprising the question and the answer to generate a candidate answer conditioned on a concatenation of the first single-modal data sample and the second single-modal data sample in the dataset in response to a training query;
building, at a server, the AI conversation bot through an application programming interface (API) to the trained second neural network language model; and
generating, using the AI conversation bot, a response to the task request conditioned on the set of single-modal data samples.

2. The method of claim 1, wherein
the first single-modal data sample comprises a natural language description of a first scene, and the second single-modal data sample comprises a natural language description of a second scene; and
the first modality and the second modality comprise an audio, an image, a video, or a three-dimensional (3D) point cloud.

3. The method of claim 1, wherein the question comprises a discriminatory question between the first scene and the second scene.

4. The method of claim 1, further comprising filtering out the question in response to the question including one or more terms describing textual qualities.

5. The method of claim 1, wherein the first single-modal data sample and the second single-modal data sample are selected based on a similarity between the first single-modal data sample and the second single-modal data sample or randomness.

6. The method of claim 1, further comprising evaluating an accuracy of the answer by computing an accuracy metric based on an order of the first single-modal data sample and the second single-modal data sample, a label of the first single-modal data sample and the second single-modal data sample, or types of modalities of the first single-modal data sample and the second single-modal data sample.

7. The method of claim 1, further comprising evaluating a quality of the question and the answer by:
determining a first performance value of the first neural network based language model in response to a first evaluation input prompt combining single-modal data samples of a plurality modalities with an evaluation question associated with the single-modal data samples;
determining a mean value of a second performance value of the second neural network based language model in response to a second evaluation input prompt combining the evaluation question without the single-modal data samples and a third performance value of the first neural network based language model in response to a third evaluation input prompt combining the evaluation question with random single-modal data samples; and
computing a multimodal signal-to-noise ratio (MSNR) based on a ratio of a difference between the first performance value and the mean value over the mean value.

8. The method of claim 1, further comprising:
generating, by one or more third neural network based language models, second candidate answers with reasoning in response to a third input prompt combining the first single-modal data sample, the second single-modal data sample, and the question;
retaining the dataset in response to a percentage of the second candidate answers being consistent with the candidate answer exceeding a predetermined value; and
disregarding the dataset in response to the percentage of the second candidate answers being consistent with the candidate answer being below the predetermined value.

9. The method of claim 8, further comprising changing an order of the first single-modal data sample and the second single-modal data sample.

10. The method of claim 1, wherein the task request comprises a navigational request from an autonomous driving system, and the set of single-modal data samples comprises one or more real-time images of surroundings of the autonomous driving system and one or more videos of the surroundings of the autonomous driving system, and the method further comprises:
causing one or more control commands to be sent and executed by the autonomous driving system based on the response.

11. A system for building an artificial intelligence (AI) agent to respond to a task request from a user, the system comprising:
a memory that stores a first neural network based language model, a second neural network based language model, and a plurality of processor executable instructions;
a communication interface that receives a set of single-modal data samples of a plurality of modalities; and
one or more hardware processors that read and execute the plurality of processor-executable instructions from the memory to perform operations comprising:
selecting, by the first neural network based language model, a first single-modal data sample of a first modality and a second single-modal data sample of a second modality;
generating, by the first neural network based language model, a question associated with the first single-modal data sample and the second single-modal data sample based on a first input prompt combining one or more first examples and a first instruction to generate the question;
generating, by the first neural network based language model, an answer with a reasoning to the question based on a second input prompt combining one or more second examples and a second instruction to generate the answer;
training, the second neural network based language model, using a dataset comprising the question and the answer to generate a candidate answer conditioned on a concatenation of the first single-modal data sample and the second single-modal data sample in the dataset in response to a training query;
building, at a server, the AI conversation bot through an application programming interface (API) to the trained second neural network language model; and
generating, using the AI conversation bot, a response to the task request conditioned on the set of single-modal data samples.

12. The system of claim 11, wherein
the first single-modal data sample comprises a natural language description of a first scene, and the second single-modal data sample comprises a natural language description of a second scene; and
the first modality and the second modality comprise an audio, an image, a video, or a three-dimensional (3D) point cloud.

13. The system of claim 11, wherein the question comprises a discriminatory question between the first scene and the second scene.

14. The system of claim 11, wherein the operations further comprise filtering out the question in response to the question including one or more terms describing textual qualities.

15. The system of claim 11, wherein the first single-modal data sample and the second single-modal data sample are selected based on a similarity between the first single-modal data sample and the second single-modal data sample or randomness.

16. The system of claim 11, wherein the operations further comprise evaluating an accuracy of the answer by computing an accuracy metric based on an order of the first single-modal data sample and the second single-modal data sample, a label of the first single-modal data sample and the second single-modal data sample, or types of modalities of the first single-modal data sample and the second single-modal data sample.

17. The system of claim 11, wherein the operations further comprise evaluating a quality of the question and the answer by:
determining a first performance value of the first neural network based language model in response to a first evaluation input prompt combining single-modal data samples of a plurality modalities with an evaluation question associated with the single-modal data samples;
determining a mean value of a second performance value of the second neural network based language model in response to a second evaluation input prompt combining the evaluation question without the single-modal data samples and a third performance value of the first neural network based language model in response to a third evaluation input prompt combining the evaluation question with random single-modal data samples; and
computing a multimodal signal-to-noise ratio (MSNR) based on a ratio of a difference between the first performance value and the mean value over the mean value.

18. The system of claim 11, wherein the operations further comprise:
generating, by one or more third neural network based language models, second candidate answers with reasoning in response to a third input prompt combining the first single-modal data sample, the second single-modal data sample, and the question;
retaining the dataset in response to a percentage of the second candidate answers being consistent with the candidate answer exceeding a predetermined value; and
disregarding the dataset in response to the percentage of the second candidate answers being consistent with the candidate answer being below the predetermined value.

19. The system of claim 18, wherein the operations further comprise changing an order of the first single-modal data sample and the second single-modal data sample.

20. A non-transitory machine-readable medium comprising a plurality of machine-executable instructions which, when executed by one or more processors, are adapted to cause the one or more processors to perform operations comprising:
receiving, via a communication interface, a set of single-modal data samples of a plurality of modalities;
selecting, by a first neural network based language model, a first single-modal data sample of a first modality and a second single-modal data sample of a second modality;
generating, by the first neural network based language model, a question associated with the first single-modal data sample and the second single-modal data sample based on a first input prompt combining one or more first examples and a first instruction to generate the question;
generating, by the first neural network based language model, an answer with a reasoning to the question based on a second input prompt combining one or more second examples and a second instruction to generate the answer;
training, a second neural network based language model, using a dataset comprising the question and the answer to generate a candidate answer conditioned on a concatenation of the first single-modal data sample and the second single-modal data sample in the dataset in response to a training query;
building, at a server, the AI conversation bot through an application programming interface (API) to the trained second neural network language model; and
generating, using the AI conversation bot, a response to a task request conditioned on the set of single-modal data samples.
